(19) United States
(12) Patent Application Publication
(10) Pub. No.: US 2004/0080776 A1
(43) Pub. Date: Apr. 29, 2004

(54) Image forming devices, imaging forming systems and image forming device operational methods

(76) Inventor: Elias S. Garcia, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/282,442

(22) Filed: Oct. 28, 2002

(51) Int. Cl. G06F 3/12; G06F 15/00; G06F 11/30; G06F 13/00

(52) U.S. Cl. 358/1.14; 358/1.15; 710/19; 713/200

(57) ABSTRACT

Image forming devices, image forming systems, and image forming device operational methods are described. According to one aspect, an image forming device includes an image engine configured to form hard images upon media responsive to a plurality of image jobs comprising image data, processing circuitry configured to present the image data of one of the image jobs to the image engine, to detect an error condition with respect to imaging of the one of the image jobs, and to present image data of another of the image jobs to the image engine after the detection of the error condition and prior to correction of the error condition wherein the image forming device would be enabled to form a hard image upon the media responsive to the image data of the one of the image jobs, and wherein the image engine is configured to form a hard image upon the media responsive to the image data of the another of the image jobs after the detection of the error condition and during the presence of the error condition.

### BACKGROUND OF THE INVENTION

Digital processing devices, such as personal computers, notebook computers, workstations, pocket computers, etc., are commonplace in workplace environments, schools, and homes and are utilized in a variety of education, work, and entertainment applications. Peripheral devices of increased capabilities have been developed to interface with the processing devices to enhance operations of the processing devices and to provide additional functionality.

For example, it is often desired to form images which may be depicted using a computer monitor or other display device upon media. A variety of printer configurations including inkjet, laser and impact printers have been developed to implement imaging operations. More recently, additional devices have been configured to interface with processing devices and include, for example, multiple-function devices, copy machines, and facsimile devices.

In some printer arrangements, print jobs may be received within a printer from a single host device or a plurality of host devices. For example, printers may be utilized in stand alone, dedicated applications wherein a single host device sends jobs to the printer, or in a networked arrangement wherein a plurality of host devices send jobs to the printer.

Printers use consumables, such as imaging media (e.g., paper) and toner, to print received jobs. During printing operations, consumables may be completely expended rendering the printer unable to formulate or print additional jobs for a period of time. Other conditions may exist which prevent the printer from printing a current job, and include paper jams, open access doors, etc. The printer may require human attention if a print job is sent which requires an attribute that the device does not have, or otherwise requires human attention for corrective action before printing operations can proceed.

In situations wherein the printer is unable to print the job, the printer may display an error condition upon a user panel and communicate a message to the user. For example, if a received job requires a certain unavailable paper size or type, the device may issue a message on a front panel asking for the user to provide the paper. The printer stops processing other jobs until the condition with respect to the current job is cleared. This operation creates a job “logjam” wherein other incoming print jobs are backlogged and are not processed or printed. In a network situation, a printer server queue may grow and other pending jobs may be halted and accumulate in the server queue until the job with the associated error condition has been corrected. These operations have numerous downsides including perhaps extended periods of idle time wherein no jobs are printed and subsequent jobs are continually received but not processed.

Aspects of the invention provide improved image forming devices, image forming systems and image forming device operational methods. Additional aspects are disclosed as is apparent from the following description and figures of exemplary embodiments of the invention.

### DESCRIPTION OF THE DRAWINGS

FIG. 1 is a functional block diagram of an exemplary image forming system.

FIG. 2 is a functional block diagram of an exemplary image forming device of the depicted system of FIG. 1.

FIG. 3 is a flow chart depicting exemplary operations of an image forming device.

FIG. 4 is a flow chart depicting additional exemplary operations of the image forming device.

### DETAILED DESCRIPTION

According to one aspect, an image forming device comprises an image engine configured to form hard images upon media responsive to a plurality of image jobs comprising image data, processing circuitry configured to present the image data of one of the image jobs to the image engine, to detect an error condition with respect to imaging of the one of the image jobs, and to present image data of another of the image jobs to the image engine after the detection of the error condition and prior to correction of the error condition wherein the image forming device would be enabled to form a hard image upon the media responsive to the image data of the one of the image jobs, and wherein the image engine is configured to form a hard image upon the media responsive to the image data of the another of the image jobs after the detection of the error condition and during the presence of the error condition.

According to another aspect, an image forming device comprises imaging means for forming hard images upon media responsive to a plurality of image jobs and processing means for communicating with the imaging means, for detecting an error condition with respect to one of the image jobs wherein the image forming device is unable to form a hard image for the one of the image jobs without user attention, for accessing another of the image jobs, and for forwarding the another of the image jobs to the imaging means after the detecting and the accessing, and wherein the imaging means comprises means for forming a hard image upon the media responsive to the another of the image jobs after the forwarding and during the presence of the error condition.

According to an additional aspect, an image forming system comprises a job management device configured to receive a plurality of image jobs from at least one host device and to output the image jobs and an image forming device configured to communicate with the job management device, to receive an initial image job from the job management device and a subsequent image job from the job management device after the reception of the initial image job, to detect an error condition with respect to a formation of a hard image corresponding to the initial image job, and to form a hard image upon media and corresponding to the subsequent image job after the detection of the error condition and prior to correction of the error condition wherein the image forming device would be configured to form the hard image upon the media and corresponding to the initial image job.

According to an additional aspect, an image forming device operational method comprises providing an image forming device, accessing a plurality of image jobs using the image forming device, attempting to form a hard image of one of the image jobs, detecting an error condition with respect to the attempting, and forming a hard image of another of the image jobs after the detecting and during the presence of the error condition.

According to yet another aspect, an image forming device comprises an image engine configured to print received image data and processing circuitry configured to a) present first image data derived from a first image job to the image engine, b) detect an error condition that prevents the first image data from being completely printed by the image engine, and c) present second image data derived from a second image job to the image engine after the detection of the error condition and prior to correction of the error condition.

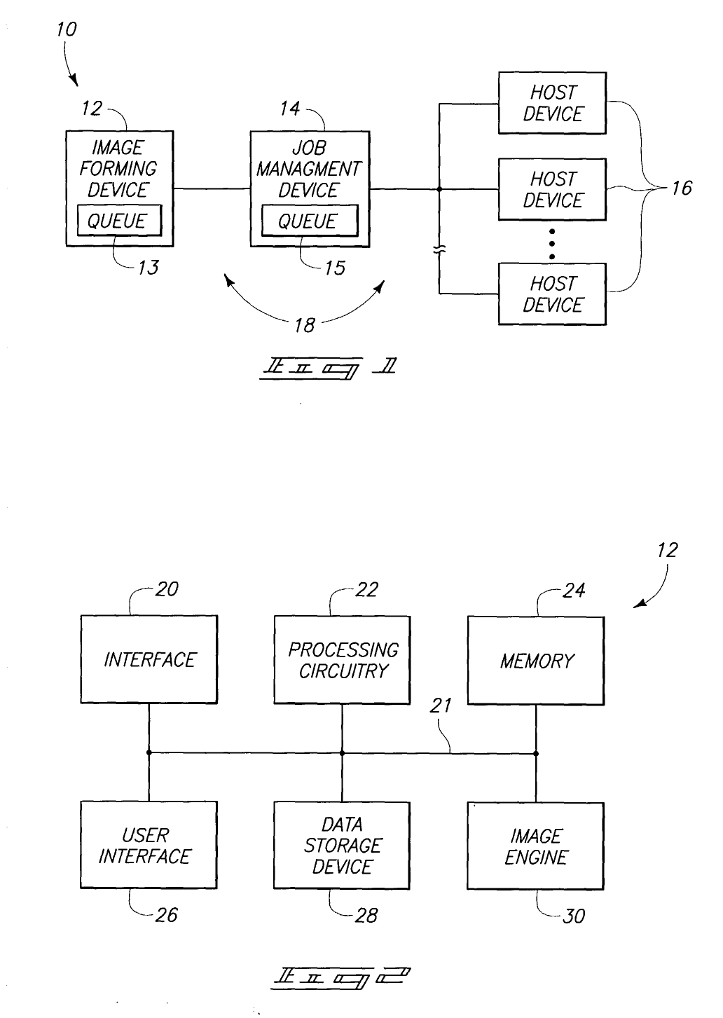

FIG. 1 depicts an exemplary image forming system 10 including an image forming device 12, a job management device 14, one or more host device 16, and a network 18. A plurality of image forming devices 12 may be utilized and coupled with network 18 in other embodiments. Network 18 may be implemented in a private network arrangement (such as an intranet), public network arrangement, (such as the Internet), a combination of private and public network devices, or other configurations capable of communicating digital information. Accordingly, in at least one configuration, network 18 implements bidirectional communications between image forming device 12, job management device 14 and one or more host device 16. In other exemplary arrangements, image forming device 12 may be utilized as a stand alone device or coupled directly with one of host devices 16 for use in a dedicated arrangement.

Image forming device 12 is arranged to generate hard images upon media such as paper, labels, transparencies, roll media, etc. Hard images include images physically rendered upon physical media. Exemplary image forming devices 12 include printers, facsimile devices, copiers, multiple-function printers (MFPs) or other devices capable of forming hard images upon media. Image forming device 12 may include a queue 13 for receiving image jobs from network 18, from a host device 16, or from another source. Aspects of the queue 13 may be embodied within memory of image forming device 12 discussed below.

Job management device 14 is provided in the depicted exemplary arrangement to facilitate handling of image jobs between host devices 16 and image forming device 12. Job management device 14 is configured to receive and store image jobs within a queue 15 in the exemplary depicted configuration. Job management device 14 including queue 15 is arranged to store image jobs received from one or more host device 16 in a predefined order according to the order of reception of the image jobs within-device 14. Job management device 14 may selectively communicate image jobs from queue 15 to an appropriate image forming device 12. The described device 14 may be implemented as a printer server in one exemplary configuration. In other arrangements, job management device 14 is omitted and host device(s) 16 interface directly with image forming device 12.

Host devices 16 formulate and communicate image jobs according to at least one embodiment of the invention. Image jobs may be addressed to job management device 14 or directly to image forming device 12. Exemplary host devices 16 include personal computers, notebook computers, workstations, servers and any other devices capable of communicating digital information. Host devices 16 may be arranged to execute appropriate application programs, such as word processing programs, spreadsheets programs or other programs, having associated image jobs wherein physical rendering of the jobs is desired.

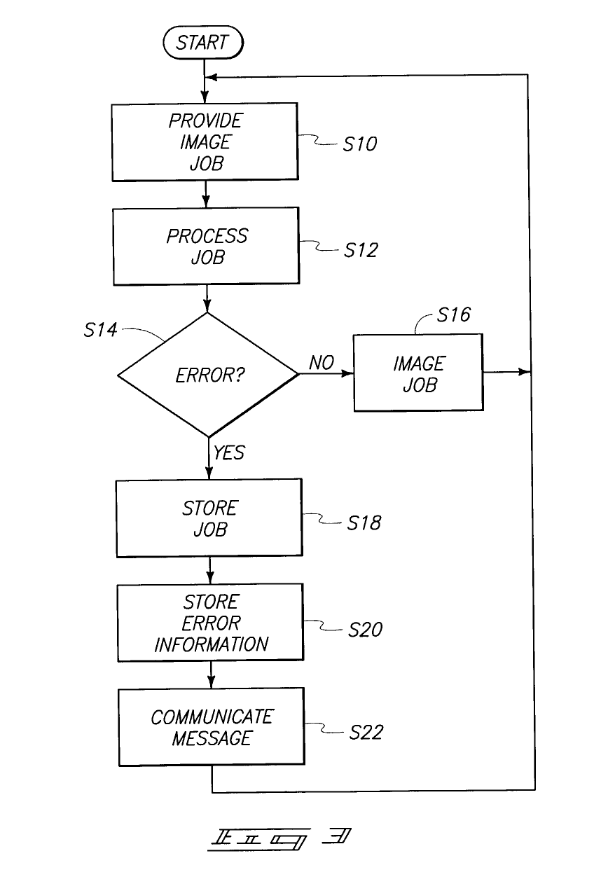

Referring to FIG. 2, an exemplary configuration of image forming device 12 includes an interface 20, a bus 21, processing circuitry 22, a memory 24, a user interface 26, a data storage device 28, and an image engine 30. Bus 21 is implemented to provide communications between appropriate components of image forming device 12. Some of the depicted components of image forming device 12 are optional and other arrangements of device 12 configured to form hard images are possible. The exemplary embodiment herein will be discussed with reference to a printer configuration although the present invention applies to other image forming device configurations capable of forming hard images as mentioned above.

Interface 20 may be referred to as a communications interface and is arranged to couple with a medium of network 18 and to implement input/output communications between image forming device 12 and external devices, such as job management device 14, host devices 16 or other appropriate devices. Interface 20 may be implemented in any appropriate configuration depending upon the application of image forming device 12. For example, interface 20 may be embodied as a network interface card (NIC) in one embodiment.

Processing circuitry 22 may be implemented as a microprocessor arranged to execute executable code or programs to control operations of image forming device 12 and process received imaged jobs. Processing circuitry 22 may execute executable instructions stored within memory 24, within data storage device 28 or within another appropriate device, and embodied as, for example, software and/or firmware instructions.

In the described exemplary embodiment, processing circuitry 22 may be referred to as a formatter or provided upon a formatter board. Processing circuitry 22 may be arranged to provide rasterization, manipulation and/or other processing of received data to be imaged. For example, image jobs including data to be imaged may be provided or received within image forming device 12 as application data (e.g., .doc file, .wpd file, .xls file, .pdf file, etc.) in an exemplary driverless printing environment. Processing circuitry 22 may convert the application data to raster data to be imaged-using image engine 30. Alternatively, data provided in device 12 may include page description language (PDL) data, such as printer command language (PCL) data or Postscript data. Processing circuitry 22 operates to rasterize the received PDL data to provide bitmap representations of the received data for imaging using image engine 30. Processing circuitry 22 presents the rasterized data to the image engine 30 for imaging. Image data may refer to any data desired to be imaged and may include application data, PDL data, rasterized data or other data.

Memory 24 stores digital data and instructions. For example, memory 24 is configured to store image data, executable code, and any other appropriate digital data to be stored within image forming device 12. Memory 24 may be implemented as random access memory (RAM), read only memory (ROM) and/or flash memory in one example.

User interface 26 is arranged to depict status information regarding operations of image forming device 12. Processing circuitry 22 may monitor operations of image forming device 12 and control user interface 26 to depict such status information. In one possible embodiment, user interface 26 is embodied as a liquid crystal display (LCD) although other configurations are possible. User interface 26 may also include a keypad or other input device for receiving user commands or other input.

Data storage device 28 is configured to store relatively large amounts of data in at least one configuration and may be configured as a mass storage device. For example, data storage device 28 may be implemented as a hard disk (e.g., 20 GB, 40 GB) with associated drive components. Data storage device 28 may be arranged to store executable instructions usable by processing circuitry 22 and image data of image jobs provided within image forming device 12. For example, data storage device 28 may store received data of imaged jobs, processed data of image jobs, or other image data.

Image engine 30 uses consumables to implement the formation of hard images. In one exemplary embodiment, image engine 30 is embodied as a print engine and includes a developing assembly and a fusing assembly (not shown) to form the hard images using developing material, such as toner, and to affix the developing material to the media to print images upon media. Other constructions or embodiments of image engine 30 are possible including configurations for forming hard images within copy machines, facsimile machines, MFPs, etc. Image engine 30 may include internal processing circuitry (not shown), such as a microprocessor, for interfacing within processing circuitry 22 and controlling internal operations of image engine 30.

Exemplary operations of image forming device 12 and image forming system 10 according to aspects of one embodiment of the invention are described below. Aspects of one embodiment of the invention accommodate the occurrence of error conditions encountered during imaging operations within image forming device 12. Exemplary error conditions may occur with respect to imaging of one or more image jobs and include a condition wherein image forming device 12 is unable to form a hard image of one of the image jobs without user attention to correct the error condition (e.g., providing image forming device 12 in a state capable of imaging the job(s)). Exemplary error conditions include a lack of an appropriate consumable (e.g., toner, appropriate size of media, etc.), a paper jam, an ajar door, or other event which precludes the initiation or completion of imaging of an image job without user intervention.

As mentioned above, and in at least one arrangement, processing circuitry 22 provides image data of a received image job in an appropriate format for imaging using image engine 30. For example, processing circuitry 22 may provide rasterized data to image engine 30 for imaging. Image forming device 12 is arranged to detect the presence of error conditions with respect to imaging of the image jobs. For example, image engine 30 may indicate an error condition to processing circuitry 22 following presentation of rasterized data to image engine 30. Alternatively, processing circuitry 22 may monitor internal status conditions of image forming device 12 to detect error conditions which may render device 12 unable to image the image job at a given moment in time. For example, processing circuitry 22 may poll one or more sensor (not shown) monitoring status conditions of image forming device 12 which may result in the presence of error conditions. Exemplary sensors may monitor a remaining amount of a consumable, media jams or ajar doors and provide the information to processing circuitry 22. Other structure or methods may be utilized to detect the presence of error conditions.

Aspects of one embodiment of the present invention enable imaging operations of image forming device 12 to continue following the detection of an error condition for one or more of the image jobs and prior to correction or rectification of the error condition. In one embodiment, processing circuitry 22 controls storage of image data of the image job having the associated error condition within data storage device 28 or other appropriate storage location, perhaps external of image forming device 12, after the detection of the error condition. Accordingly, image data including received data, rasterized data or other data for an image job may be stored within data storage device 28 following the occurrence of an error condition with respect to the image job. Storage of the image job enables image forming device 12 to later image the stored job following correction of the error condition. In some implementations, image jobs having associated error conditions may be communicated externally of device 12 (e.g., back to job management device 14), disregarded, or otherwise handled to permit image forming device 12 to continue to process other image jobs and before correction of the encountered error condition.

Processing circuitry 22 may also control storage of information regarding the error condition along with and associated with the stored image data. Exemplary information regarding the error condition can include, for example, an identifier of the appropriate sized media needed to complete the image job, identifiers of other depleted consumables, information regarding a paper jam of a particular type of paper, etc. The information regarding the error condition may be stored in device 28 or other appropriate location.

Additionally, processing circuitry 22 may generate and associate a unique identifier with the image job stored within data storage device 28 or other location. As described below, the identifier may be utilized by a user to access the stored image job at a later moment in time.

In some arrangements, host device 16 or job management device 14 may include appropriate security information with one or more image job. The security information may include a confidential code inputted by a user to access or cause image forming device 12 to formulate the hard images for the image job. The security data may be communicated to image forming device 12 along with the image data for the image job. If a received image job includes security data, such security data may be stored with a stored image job having an associated error condition to maintain the secure status of the image job upon correction of the error condition. For example, a user attempting to cause image forming device 12 to image the respective job following correction of the error condition may be prompted to implement the appropriate code prior to initiation of imaging operations for the job.

Processing circuitry 22 is arranged to count a number of image jobs stored within device 28 in one embodiment. Processing circuitry 22 may halt operations of device 12 if the number of stored jobs reaches a predefined number to prevent overflow conditions if space of device 28 is consumed according to this embodiment. Imaging using device 12 may proceed after the error condition is corrected.

Additional aspects provide monitoring of types of error conditions using processing circuitry 22 to control storage of image jobs. For example, the presence of one class of errors (e.g., lack of media size, type, etc.) identified by circuitry 22 would result in storage operations of jobs as described herein while another class of errors (e.g., catastrophic or hard errors such as a developer failure) would halt imaging operations of device 12 and halt storage of jobs until the error condition is corrected. Accordingly, jobs may be selectively stored responsive to identification of the type of error condition in at least one configuration.

According to additional aspects of this embodiment, processing circuitry 22 is arranged to control communications interface 20 to output a message regarding the error condition externally of image forming device 12 and responsive to the detection of the error condition. Exemplary messages include e-mail messages although messages of other formats are possible. The message may also identify the job having the associated error condition.

In one messaging arrangement, processing circuitry 22 extracts an identifier of the host device 16 which originated the image job having the associated error condition and addresses the message using the identifier for communication to the appropriate host device, 16. Accordingly, in at least one aspect, processing circuitry 22 is arranged to control the communication of the message to a predefined device determined by the originator of the image job.

In another arrangement, processing circuitry 22 may be configured to control communications to another predefined device, such as one of host devices 16 associated with administrative personnel. The administrative personnel may be in charge or responsible for correcting error conditions within image forming device 12. Sending messages as described in the exemplary aspects lets the user who originated the image job, an administrator and/or other appropriate personnel know that the image job has an associated error condition and may not be processed absent user attention.

Processing circuitry 22 may enable a timer operation following the detection of an error condition. Thereafter, processing circuitry 22 may control storage of the image data or otherwise dispose of the image job having the error condition after the elapse of a period of time defined by the timer and without correction of the error condition.

According to additional aspects, and after the detection of an error condition with respect to one of the image jobs (e.g., may be referred to as a previous or initial image job), processing circuitry 22 may initiate a request to job management device 14 for a subsequent image job from queue 15. Job management device 14 may communicate another image job to image forming device 12 responsive to receiving the request. Processing circuitry 22 proceeds to implement any processing of the received data of the subsequent image job to provide appropriate image data for use in image engine 30. Accordingly, processing circuitry 22 is arranged to present the image data to the image engine 30 after the detection of the error condition with respect to the previous image job and perhaps prior to correction of the error condition wherein the image forming device 12 would be enabled to form a hard image upon the media responsive to the image data of the previous image job.

Image engine 30 forms one or more hard image upon media responsive to the image data of the subsequent image job after the detection of the error condition with respect to the previous or initial image job. Image engine 30 may form the one or more hard image of the subsequent image job during the presence of the error condition and prior to the correction of the error condition in at least one exemplary operational aspect of one embodiment of the invention. Processing of the subsequent image job and imaging of hard images using image engine 30 may be implemented if the error condition detected for the first image job does not impact or prevent imaging of the second image job (e.g., the subsequent image job utilizes a different consumable than a consumable which caused the error condition with respect to the initial image job).

Exemplary operational aspects enable image forming device 12 and image engine 30 to continue to operate to process and image subsequent jobs after the detection of an error condition with respect to an initial image job. As described below, aspects are also provided to enable processing and/or imaging of the initial job following appropriate correction of the respective error condition.

A system administrator, user, or other entity, may obtain information regarding an error condition from a communicated message from image forming device 12, monitoring the status of user interface 26, or investigating the status of image forming device 12 in other ways. The system administrator or other user may correct the error condition within the image forming device 12 (e.g., replacing the expended consumable). Following correction, the system administrator may enter a command via user interface 26 to indicate the correction of the error condition. Processing circuitry 22 may receive the status information inputted via user interface 26 regarding correction of the error condition or otherwise detect the correction of the error condition (e.g., polling sensors monitoring the error condition).

According to additional aspects, image jobs having error conditions may be processed and/or imaged following correction of the error condition. For example, processing circuitry 22 may maintain a log or index of identifiers of image jobs having error conditions and which have been stored in device 28 or other appropriate location. The log or index may be stored within memory 24 or other appropriate location.

A user may utilize user interface 26 to access the index or log of stored jobs within data storage device 28. The user may scroll through the index displayed within user interface 26 to locate the appropriate image job having the corrected error condition, retrieve the image job, enter security information if appropriate and initiate imaging of the image job having the corrected error condition. The user may also use the index to obtain information regarding the nature of the error condition if stored within device 28 as mentioned above.

Processing circuitry 22 may proceed to implement any remaining processing of the retrieved image job. Processing circuitry 22 presents appropriate image data to the image engine 30 after the correction of the error condition and retrieval of the image job. Thereafter, image engine 30 forms one or more hard image upon the media using the retrieved image data for the image job and after the correction of the error condition.

Device 12 may also retain stored jobs in device 28 following unsuccessful attempted correction of the error condition. For example, if device 12 is unable to completely image the job after an attempt to correct the error condition, processing circuitry 22 may retain the storage of the job in device 28 and proceed to process and control imaging of other jobs.

Accordingly, image forming device 12 may be enabled to accommodate error conditions and to continue to process and image pending image jobs during the presence of error conditions. The device 12 may be further enabled to retrieve and image image jobs having error conditions following the correction of the respective error conditions.

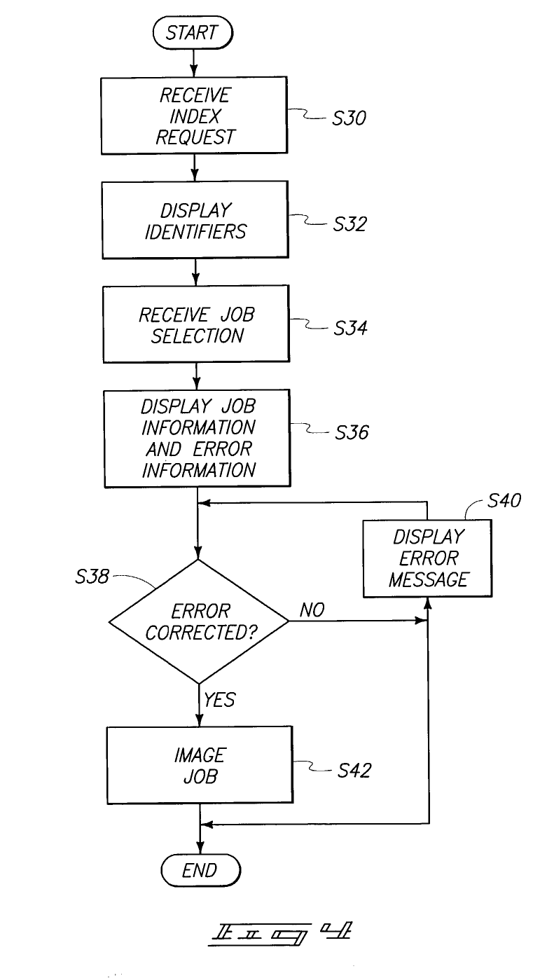

Referring to FIGS. 3-4, exemplary operational methods executable by processing circuitry 22 of image forming device 12 to implement embodiments of the invention are illustrated. The depicted methodologies may be embodied as executable code within memory 24 and/or data storage device 28 and executed by processing circuitry 22 or other appropriate circuitry of image forming device 12. The methodologies are presented to illustrate exemplary steps for performing some aspects of one embodiment, of the invention. Other methods are possible including more, less or alternative steps.

Referring specifically to FIG. 3, exemplary operations regarding imaging of image jobs and attempted imaging of image jobs are described.

At a step S10, an image job is provided within the image forming device and detected by the processing circuitry. For example, the job, management device may communicate the image job to the image forming device.

At a step S12, the processing circuitry proceeds to process the image job including rasterization of the received data and attempts to control the image forming device to form one or more hard image of the image job.

At a step S14, it is determined whether an error condition is present with respect to imaging of the image job.

If not, the processor provides the image job to the image engine which proceeds to image the job at a step S16. In other exemplary arrangements, an error condition may not be detected until after forwarding of an image job to the image engine or at other times during the imaging process.

If the condition of step S14 is affirmative, the processing circuitry proceeds to a step S18 to store the image job within the data storage device. The processing circuitry may also store an identifier of the respective stored image job within an index. If provided, security information may also be stored with the respective image job within the data storage device to maintain secure printing attributes upon later accessing of the image job.

At a step S20, the processing circuitry may also store error information associated with the respective image job indicating the error condition(s) of the respective image job. The processing circuitry may store the error information within the data storage device and/or memory.

At a step S22, the processing circuitry formulates and communicates a message to an appropriate recipient indicating the presence of the error condition during the attempted imaging of the image job. The message may be addressed to a predefined device, such as the originating host device of the image job and/or the device of another entity.

Thereafter, the processing circuitry may return to a step S10 to access additional image jobs from an internal queue of the image forming device, from a queue of a job management device, or other appropriate source.

Referring now to FIG. 4, exemplary operations regarding retrieval and imaging of image jobs having error conditions are described.

At a step S30, the processing circuitry receives an index or log request inputted by a user via the user interface.

At a step S32, the processing circuitry controls the user interface to display identifiers and other appropriate information regarding image jobs stored within data storage device within an index or log.

At a step S34, the processing circuitry receives a job selection from a user inputted using the user interface.

At a step S36, the processing circuitry controls the user interface to display job information, error information and other appropriate information, such as security information, with respect to the requested image job selected in step S34.

At a step S38, the processing circuitry determines whether the error condition associated with the selected image job has been corrected.

If the condition of step S38 is negative, the processing circuitry proceeds to a step S40 to control the user interface to display an error message regarding the error condition of the selected image job. Thereafter, the processing circuitry may return to step S38 to determine whether the error has been corrected.

If the condition of step S38 is affirmative, the processing circuitry may proceed to a step S42 to perform any processing and to forward the image data to image engine 30 for imaging.

The protection sought is not to be limited to the disclosed embodiments, which are given by way of example only, but instead is to be limited only by the scope of the appended claims.

What is claimed is:

1. An image forming device comprising:
an image engine configured to form hard images upon media responsive to a plurality of image jobs comprising image data;
processing circuitry configured to present the image data of one of the image jobs to the image engine, to detect an error condition with respect to imaging of the one of the image jobs, and to present image data of another of the image jobs to the image engine after the detection of the error condition and prior to correction of the error condition wherein the image forming device would be enabled to form a hard image upon the media responsive to the image data of the one of the image jobs; and
wherein the image engine is configured to form a hard image upon the media responsive to the image data of the another of the image jobs after the detection of the error condition and during the presence of the error condition.

2. The device according to claim 1 wherein the image forming device is unable to form the hard image of the one of the image jobs without user attention to correct the error condition.

3. The device according to claim 1 further comprising a data storage device, and wherein the processing circuitry is configured to control storage of the image data of the one of the image jobs within the data storage device after the detection of the error condition.

4. The device according to claim 3 wherein the processing circuitry is configured to control storage of the image data of the one of the image jobs after the elapse of a predefined period of time.

5. The device according to claim 3 further comprising a communications interface configured to receive the image data and security data associated with the one of the image jobs, and wherein the processing circuitry is configured to control storage of the security data of the one of the image jobs associated with the stored image data within the data storage device.

6. The device according to claim 5 wherein the security data is configured to restrict access of a user to the image data.

7. The device according to claim 3 wherein the processing circuitry is configured to control storage of information regarding the error condition and associated with the stored image data within the data storage device.

8. The device according to claim 3 further comprising a user interface, and wherein the processing circuitry is configured to control the user interface to depict an identifier of the stored image data.

9. The device according to claim 1 wherein:
the image forming device has access to a data storage device; and
the processing circuitry is configured to store at least a portion of the first image job in the data storage device in the form of rasterized data after the detection of the error condition.

10. The device according to claim 1 wherein the image engine is configured to form the hard image upon the media responsive to the image data of the another of the image jobs and prior to the correction of the error condition.

11. The device according to claim 1 further comprising a communications interface, and wherein the processing circuitry is configured to control the communications interface to output a message regarding the error condition externally of the image forming device responsive to the detection of the error condition.

12. The device according to claim 11 wherein the processing circuitry is configured to control the communication of the message to a pre-identified device.

13. The device according to claim 11 wherein the processing circuitry is configured to control the communication of the message to an originating device of the first image job.

14. The device according to claim 1 wherein the processing circuitry is configured to detect the correction of the error condition and to present the image data of the one of the image jobs to the image engine after the correction of the error condition, and wherein,the image engine is configured to form the hard image upon the media responsive to the image data of the one of the image jobs after the correction of the error condition.

15. The device according to claim 1 wherein the image engine comprises a print engine configured to print hard images upon the media.

16. An image forming device comprising:
imaging means for forming hard images upon media responsive to a plurality of image jobs; and
processing means for communicating with the imaging means, for detecting an error condition with respect to one of the image jobs wherein the image forming device is unable to form a hard image for the one of the image jobs without user attention, for accessing another of the image jobs, and for forwarding the another of the image jobs to the imaging means after the detecting and the accessing, and wherein the imaging means comprises means for forming a hard image upon the media responsive to the another of the image jobs after the forwarding and during the presence of the error condition.

17. The device according to claim 16 further comprising data storage means for storing the one of the image jobs within the data storage device after the detection of the error condition.

18. The device according to claim 17 further comprising communications means for receiving the image jobs and security data associated with the one of the image jobs, and wherein the processing means comprises means for controlling storage of the security data associated with the stored one of the image jobs within the data storage means.

19. The device according to claim 17 further comprising user interface means for depicting an identifier of the stored one of the image jobs.

20. The device according to claim 16 wherein the imaging means comprises means for forming the hard image responsive to the another of the image jobs prior to correction of the error condition.

21. The device according to claim 16 further comprising communications means for communicating a message regarding the error condition externally of the image forming device.

22. The device according to claim 16 wherein the imaging means comprises print means for printing hard images upon the media.

23. An image forming system comprising:
a job management device configured to receive a plurality of image jobs from at least one host device and to output the image jobs; and
an image forming device configured to communicate with the job management device, to receive an initial image job from the job management device and a subsequent image job from the job management device after the reception of the initial image job, to detect an error condition with respect to a formation of a hard image corresponding to the initial image job, and to form a hard image upon media and corresponding to the subsequent image job after the detection of the error condition and prior to correction of the error condition wherein the image forming device would be configured to form the hard image upon the media and corresponding to the initial image job.

24. The system according to claim 23 wherein the image forming device is unable to form the hard image corresponding to the initial image job without user attention.

25. The system according to claim 23 wherein the job management device is configured to receive the image jobs from a plurality of host devices and to store the initial image job and the subsequent image job in a queue in an order according to the order of reception of the initial image job and the subsequent image job.

26. The system according to claim 23 wherein the image forming device is configured to store the initial image job after the detection of the error condition.

27. The system according to claim 26 wherein the image forming device is configured to store information regarding the error condition and associated with the stored initial image job.

28. The system according to claim 26 wherein the image forming device is configured to display an identifier of the stored initial image job.

29. The system according to claim 26 wherein the image forming device is configured to store the initial image job in the form of rasterized data.

30. The system according to claim 23 wherein the image forming device is configured to communicate a message regarding the error condition and that identifies the initial image job externally of the image forming device after the detection of the error condition.

31. The system according to claim 23 wherein the image forming device is configured to detect the correction of the error condition and to form the hard image corresponding to the initial image job after the correction.

32. The system according to claim 23 wherein the job management device comprises a print server and the image forming device comprises a printer.

33. An image forming device operational method comprising:
providing an image forming device;
accessing a plurality of image jobs using the image forming device;
attempting to form a hard image of one of the image jobs;
detecting an error condition with respect to the attempting; and
forming a hard image of another of the image jobs after the detecting and during the presence of the error condition.

34. The method according to claim 33 wherein the detecting comprises detecting the error condition wherein the image forming device is unable to form the hard image of the one of the image jobs without user attention.

35. The method according to claim 33 further comprising storing the one of the image jobs after the detecting.

36. The method according to claim 35 further comprising storing security data of the stored one of the image jobs associated with the stored one of the image jobs after the detecting.

37. The method according to claim 35 further comprising storing information regarding the error condition and associated with the stored one of the image jobs after the detecting.

38. The method according to claim 35 wherein the storing comprises storing rasterized data of the stored one of the image jobs.

39. The method according to claim 35 further comprising identifying a type of the detected error condition, and wherein the storing is responsive to the identifying.

40. The method according to claim 35 further comprising counting a number of stored image jobs, and wherein the storing is responsive to the counting.

41. The method according to claim 33 further comprising communicating a message regarding the error condition externally of the image forming device after the detecting.

42. The method according to claim 33 further comprising addressing the message to an external device.

43. The method according to claim 33 further comprising addressing the message to an originating device of the one of the image jobs.

44. The method according to claim 33 further comprising:
receiving user intervention that corrects the error condition; and
forming the hard image of the one of the image jobs after the correcting.

45. The method according to claim 33 wherein the providing the image forming device comprises providing a printer and the forming comprises printing the hard image.

46. An image forming device comprising:
an image engine configured to print received image data; and
processing circuitry configured to:
(a) present first image data derived from a first image job to the image engine,
(b) detect an error condition that prevents the first image data from being completely printed by the image engine, and
(c) present second image data derived from a second image job to the image engine after the detection of the error condition and prior to correction of the error condition.

47. The device according to claim 46 wherein the error condition is of a type that requires user attention to correct.

48. The device according to claim 46 wherein:
the image forming device has access to a data storage device; and
the processing circuitry is configured to automatically store at least a portion of the first image job to the data storage device after the detection of the error condition.
